(19) United States
(12) Patent Application Publication
(10) Pub. No.: US 2017/0051676 A1
(43) Pub. Date: Feb. 23, 2017

(54) TURBINE COMBUSTION CHAMBER PRESSURE ASSISTED CONTROL VALVE

(71) Applicant: Moog Inc., East Aurora, NY (US)

(72) Inventor: David GEIGER, Orchard Park, NY (US)

(21) Appl. No.: 15/306,985

(22) PCT Filed: Apr. 28, 2014
(86) PCT No.: PCT/US2014/035633

§ 371 Date: Oct. 26, 2016

(51) Int. Cl. F02C 7/232; F16K 17/36

(52) U.S. Cl. CPC F02C 7/232; F16K 17/36

(57) ABSTRACT

A combustion turbine control valve comprising a fuel passage to a combustion chamber, a control valve assembly to meter fuel flow to the combustion chamber, the control valve assembly comprising a metering valve body having a valve seat, a metering valve plug movable relative to the body from an open to a closed position, a chamber separated from the flow passage by the plug, the plug having a first area exposed to the chamber, a second area exposed to the flow passage when in the open position and a third area exposed to the flow passage when in the closed position, the first area being greater than the third area and equal to or less than the second area, a passage connecting the chamber and the upstream side of the flow passage, and an actuator to actuate the body between the closed and open positions.

### TECHNICAL FIELD

The present invention relates generally to gas turbine combustion chambers and, more particularly, to an improved gas turbine combustion chamber control valve.

### BACKGROUND ART

Combustion turbines generally take in air and compress the air in a compression turbine stage. Gas or oil fuel is metered into a combustion chamber and the resulting hot exhaust gas then passes over the turbine blades creating torque on a shaft. Typically the shaft is connected to a generator that then produces electricity.

The metering of the fuel in the combustion chamber can be critical because it controls the speed of the turbine as the load varies. For example, when the fuel is metered with high resolution, emissions of environmentally unfriendly gases can be lowered.

The metering of the flow of gas or oil into the combustion chamber is typically performed with a fuel control valve. A typical fuel control valve for a gas turbine utilizes a stationary metering seat and an adjustable metering plug to meter the fuel through the valve. The metering plug is connected by a valve stem to an actuator which modulates the position of the metering plug and therefore the flow of fuel through the valve. Typically the actuator is a hydraulic driven linear actuator.

### BRIEF SUMMARY OF THE INVENTION

With parenthetical reference to corresponding parts, portions or surfaces of the disclosed embodiment, merely for the purposes of illustration and not by way of limitation, the present invention provides an improved combustion turbine control valve (20) comprising a fuel intake flow passage (21) to a combustion chamber (22) of a combustion turbine (23), a control valve assembly (25) configured to meter fuel flow through the flow passage to the combustion chamber from an upstream side (26) to a downstream side (27), the control valve assembly comprising a metering valve body (30) having a valve seat (31) defining an inlet port (32) in the flow passage between the upstream side and the downstream side, a metering valve plug (33) movable relative to the metering valve body from an open position (FIG. 2) to a closed seated position (FIG. 4) to control fuel flow through the inlet port from the upstream side to the downstream side, a chamber (34) separated from the flow passage by the metering valve plug, the metering valve plug having a first pressure-affective area (A1) exposed to the chamber, a second pressure-affective area (A2) exposed to the flow passage when in the open position and a third pressure-affective area (A3) exposed to the flow passage when in the closed seated position, the metering valve body and the metering valve plug configured and arranged such that the first pressure-affective area is greater than the third pressure-affective area, and a chamber passage (35) connecting the chamber and the upstream side of the flow passage when the metering valve plug is in the closed seated position, and an actuator (36, 136) configured and arranged to actuate the metering valve body between the closed seated position and the open position, wherein, when the metering valve body is in the closed seated position, pressure in the upstream side of the passage is transferred to the chamber and will urge the metering valve body to remain in the closed seated position.

The valve seat may comprise a frusto-conical seat surface (38) and the metering valve plug may comprise a frusto-conical plug surface (40) in the second pressure-affective area of the metering valve plug. The frusto-conical plug surface may be offset (49) relative to the frusto-conical seat surface so as to engage the frusto-conical seat surface and define a circular seal (50) when the metering valve plug is in the closed seated position. The third pressure-affective area may be annular and the circular seal may be located proximate to an outer circumference (48) of the annular third pressure-affective area. The chamber passage may extend through the metering valve plug. The actuator may comprise hydraulic ports and a servo system for actuating the metering valve plug between a closed position and an open position. The actuator may comprise an electro-mechanical actuator (36) or an electro-hydrostatic actuator (136). The combustion turbine may power an electric generator (24). The first pressure-affective area may be substantially equal to or less than the second pressure-affective area. The valve assembly may further comprise a fail-safe mechanism (55) configured and arranged to bias said metering valve body toward said closed seated position, and the fail-safe mechanism may comprise a spring disposed in the chamber.

### BRIEF DESCRIPTION OF THE DRAWINGS

FIG. 1 is a schematic view of a combustion turbine with a first embodiment of an improved combustion turbine control valve assembly.

FIG. 2 is a cross-sectional view of the process valve assembly shown in FIG. 1 in an open position.

FIG. 3 is an enlarged view of the bottom of the process valve assembly shown in FIG. 2.

FIG. 4 is a cross-sectional view of the valve assembly shown in FIG. 1 in a closed position.

FIG. 5 is an enlarged view of the bottom of the valve assembly shown in FIG. 4.

FIG. 6 is an enlarged detailed view of the seal of the valve assembly shown in FIG. 5

FIG. 7 is a cross-sectional view of a second embodiment of an improved combustion turbine control valve assembly in an open position and with an electro-hydrostatic actuator.

FIG. 8 is a cross-sectional view of the valve assembly shown in FIG. 7 in a closed position.

FIG. 9 is a cross-sectional view of the valve assembly shown in FIG. 4 with a fail-safe spring.

### DETAILED DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

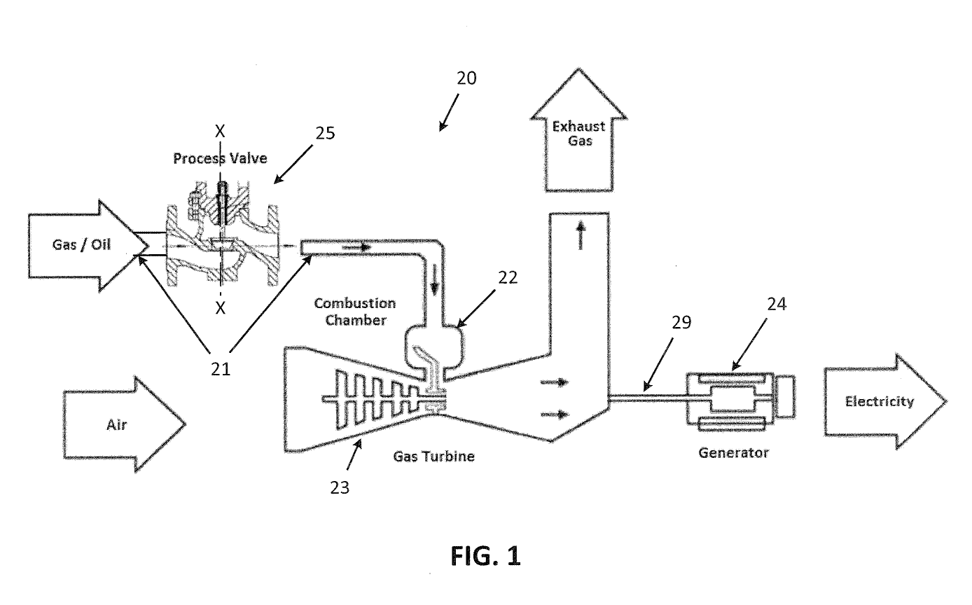

Referring now to the drawings, and more particularly to FIG. 1 thereof, a combustion turbine control valve system is provided, of which an embodiment is generally indicated at 20. As shown, combustion turbine control valve system 20 is shown as broadly including control valve assembly 25 configured to meter fuel flow through fuel intake flow passage 21 to combustion chamber 22 of a conventional combustion turbine 23. Combustion turbine 23 generally takes air and compresses the air in a compression turbine stage. Gas or oil fuel is metered into combustion chamber 22, resulting in hot exhaust gas passing over the turbine blades of gas turbine 23 and creating a torque on shaft 29 of gas turbine 23, which in turn powers electric generator 24 and produces electricity.

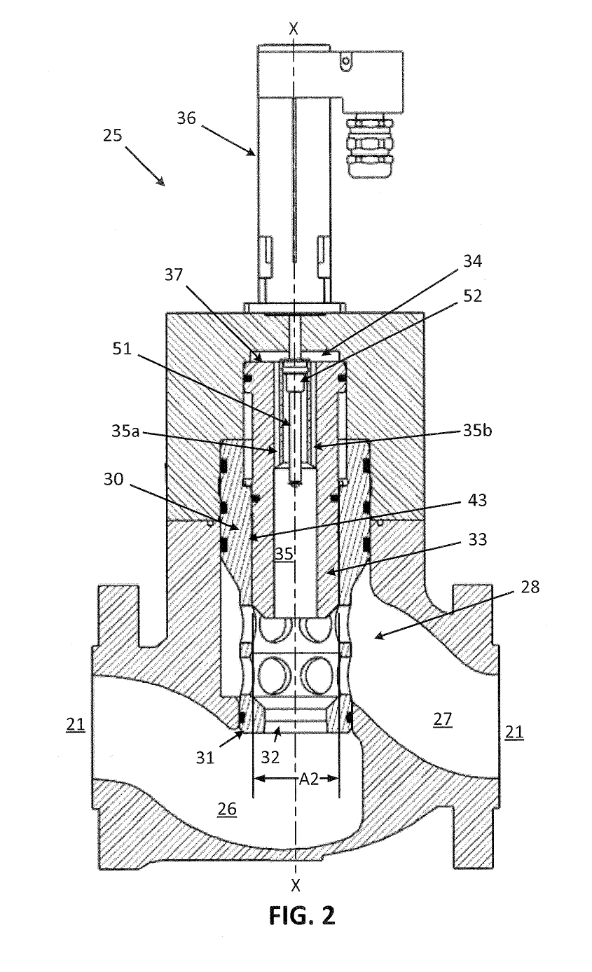

Process valve assembly 25 is provided to meter the fuel flow through fuel intake passage 21 and into combustion chamber 22. As shown in FIGS. 2-6, control valve assembly 25 is positioned in fuel intake passage 21 and generally comprises stationary valve body 30 and valve plug 33. Valve body 30 includes inlet port 32, main side outlet port 28, and cylindrical sleeve 43. Upstream side 26 of fuel intake passage 21 is on the upstream side of port 32 and downstream side 27 of fuel intake passage 21 is downstream of side outlet port 28. Port 32 is defined by inwardly-facing vertical cylindrical surface 39 and valve seat 31 is defined by upwardly and inwardly-facing frusto-conical surface 38.

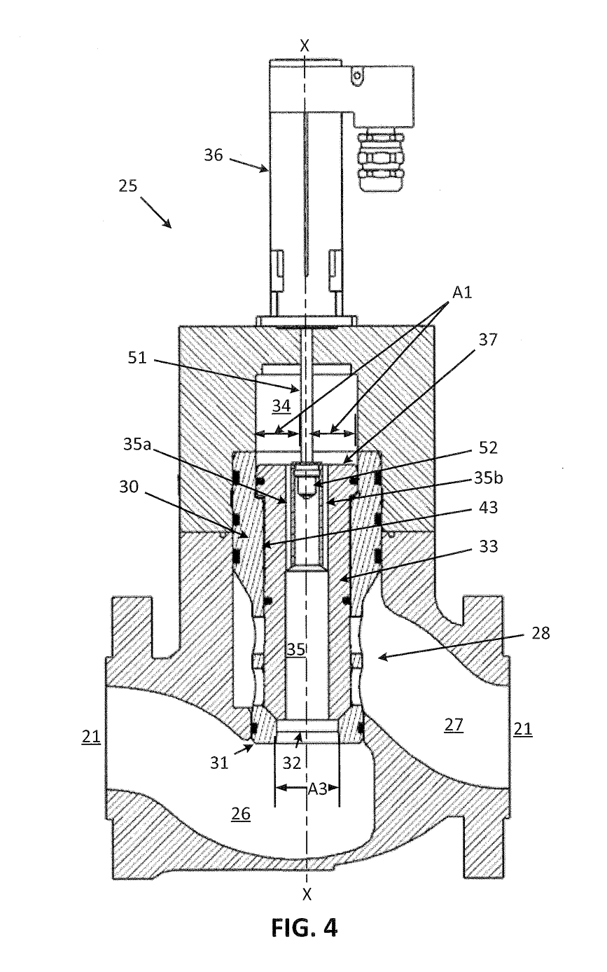

Valve plug 33 is a generally hollow cylindrical member elongated about axis x-x and slidably disposed within sleeve 43 of valve body 30 such that it is moveable longitudinally along axis x-x from an open position shown in FIG. 2 to a closed position shown in FIG. 4. As shown, cylindrical passage 35 extends through the center of valve plug 33 so as to connect chamber 34 with passage 21, and in particular the upstream side 26 of passage 21 when plug 33 is closed.

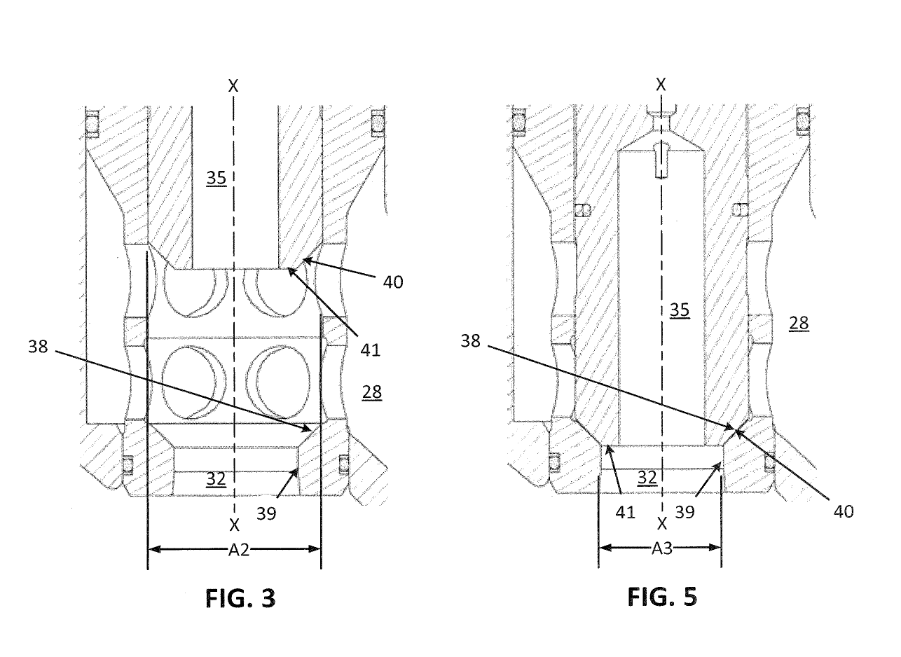

FIGS. 2 and 3 show valve assembly 25 in a fully open position, in which valve assembly 25 is metering flow to control the speed of turbine 23. In this mode, metering plug 33 has moved up and away from seat 31 such that the valve flows gas or fluid between inlet 32 and side outlet 28 at the desired rate. The amount of such flow can be controlled by moving the bottom end of valve plug closer or further away from seat 31. Specially configured flow windows in valve body 30 may be provided to obtain the desired flow versus displacement profile.

The top end of valve plug 33 has an upwardly-facing horizontal annular surface 37. Surface 37 and the inner walls of the upper portion of valve body 30 define chamber 34. Sub-passages 35a and 35b of passage 35 extends through surface 37 and connect chamber 34 to fuel passage 21 and fuel intake pressure in fuel passage 21 when plug 33 is in both the open and closed position. Upper surface 37 has a pressure-affective area value A1 that is exposed to gas or fluid in chamber 34. Because surface 37 is in a plane transverse to axis x-x and the permitted direction of travel of plug 33 in sleeve 43 of body 30, surface 37 generally defines pressure-affective area value A1, which is the area acted on by pressure in chamber 34 to apply a force in the permitted direction of travel of plug 33 in sleeve 43 of body 30, namely downward and parallel to axis x-x.

The bottom end of valve plug 33 has an outwardly and downwardly-facing frusto-conical surface 40 and a downwardly-facing horizontal annular surface 41. The bottom end of valve plug 33 has pressure-affective area value A2 that is exposed to gas or fluid received in port 32 when valve plug 33 is in the open position. This pressure-affective area value A2 is the area of the surfaces in a plane transverse to axis x-x, which is the area acted on by pressure in port 32 to apply a force in the permitted direction of travel of plug 33 in sleeve 43 of body 30, namely upward and parallel to axis x-x. Plug 33, including surface 40, is symmetrical about axis x-x so the force components from pressure transverse to axis x-x and the permitted direction of movement of plug 33 cancel each other.

As shown, pressure-affective area value A1 of the top face of plug 33 is almost equal to pressure-affective area value A2 of the bottom face of metering plug 33, such that the gas forces on the valve are almost balanced. The only difference in the area is the result of shaft 51. The circular openings of passages 35a and 35b are equal on the top face and bottom face of plug 33 and therefore balance out. Actuator 36 at this point is only required to overcome the frictional forces and accelerating forces of the valve assembly.

FIGS. 4-6 show valve assembly 25 in a fully closed or seated position. In this position, the bottom end of metering plug 33 is seated against metering seat 31 with sufficient force to assure an almost leak free seal 50. When valve plug 33 is in the closed seated position shown in FIGS. 4-6, pressure-affective area value A2 is reduced to A3. In the closed position, frusto-conical surface 40 of valve plug 33 is no longer exposed to fluid or gas and pressure on the upstream side 26 of intake port 32, thereby reducing the pressure-affective area value A2 by an amount A4. In this closed position, annular surface 41 has a pressure-affective area A3 that is exposed to gas or fluid on the upstream side of valve intake port 32. Pressure-affective area value A3 is the area acted on by pressure on the upstream side of valve intake port 32 to apply a force in the permitted direction of travel of plug 33 in sleeve 43 of body 30, namely upward and parallel to axis x-x. Again, the circular openings of passages 35a and 35b are equal on the top face and bottom face of plug 33 and therefore balance out. Thus, pressure-affective surface area value A3 is equal to pressure-affective area value A2 minus pressure-affective area value A4.

As shown, seat 31 and the bottom end face of metering plug 33 are dimensioned such that, when seated, pressure-affective area value A3 of the bottom end face 41 of metering plug 33 is less than pressure-affective area value A1 of the top end face 37 of metering plug 33, such that the differences in the pressure-affective area values A1 and A3 multiplied by the gas pressure, shared through passage 35 between the upstream side of valve intake port 32 and chamber 34, provides a sufficient seat force to keep valve 25 in the closed sealed position. With this new configuration, the actuator input force only needs to be large enough to overcome the friction forces plus the acceleration forces plus the force to initiate the seal. The sum of these forces is typically ⅓ the valve seating force requirements.

In addition, pressure-affective area value A1 is substantially equal to or less than pressure-affective area value A2. If they are substantially equal, the forces cancel and no additional load is required to actuate valve plug 33. If pressure-affective area value A1 is less than pressure-affective area value A2, then a bias towards the open position is provided.

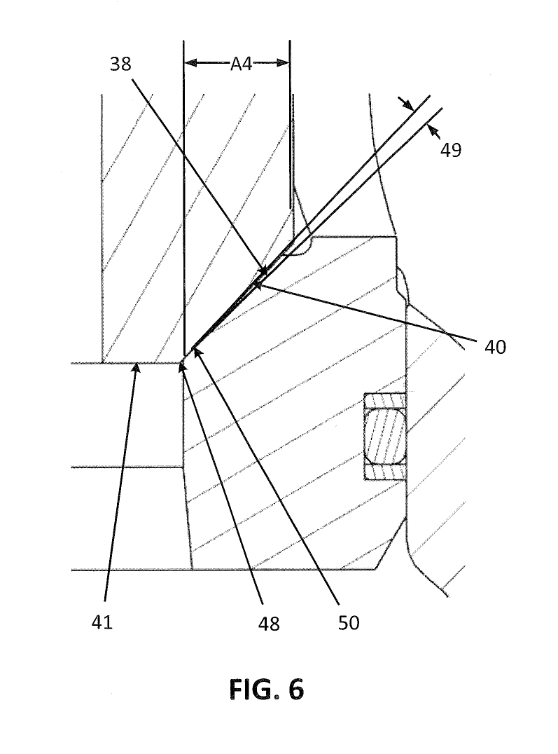

As shown in FIG. 6, frusto-conical surface 38 of seat 31 is not parallel to frusto-conical surface 40 of valve plug 33 but is offset by angle 49. Thus, valve plug 33 will close off at seal 50 proximate to the outer circumference of surface 41.

Actuator 36 is an electro-mechanical actuator (EMA) configured to actuate plug 33 in sleeve 43 between the open and closed positions. In this embodiment, an electric motor is connected through shaft 51 to a nut which converts the rotary movement of the motor to linear movement to valve plug 33. Thus, the electric motor is mechanically connected to rotate shaft 51, which has continuous helical threads machined on its circumference running along its length. Threaded onto shaft 51 is ball nut 52 with corresponding helical threads. Nut 52 is prevented from rotating with shaft 51 such that, when shaft 51 is rotated, nut 52 will be driven along the threads of shaft 51. The direction of motion of ball nut 52 depends on the direction of rotation of shaft 51 and therefor the directional rotation of the rotor of the motor. As shown, the top of plug 33 is attached to ball nut 52, such that rotational motion of the motor can be converted to linear displacement of valve plug 33.

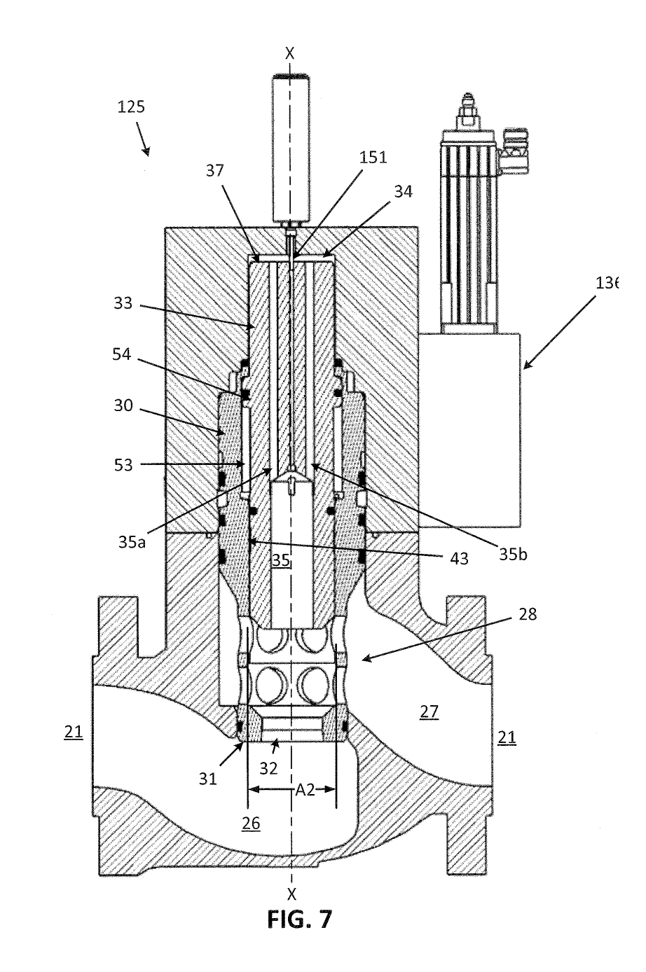

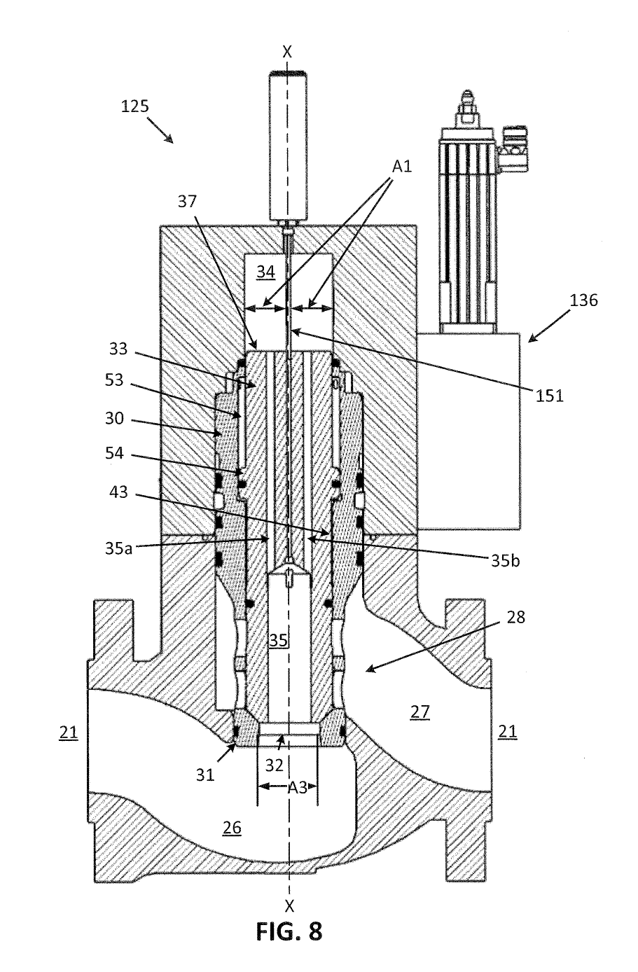

FIGS. 7 and 8 shows an alternate embodiment having electro-hydrostatic actuator (EHA) 136 configured to actuate plug 33 in sleeve 43 between the open position, shown in FIG. 7, and closed position, shown in FIG. 8. EHA 136 is a fully self-contained actuation system that receives power from an electrical source and transform an input command (usually electrical) into motion. It includes a servo-motor, a hydraulic pump, a reservoir and/or accumulator, and a servo-motor. In this embodiment, a servo-motor is used to drive the reversible pump, which is connected on both sides of cylindrical tab 54 to cylindrical hydraulic gap 53 of sleeve 43. The pump pressurizes a working fluid, typically hydraulic oil, directly raising the pressure in hydraulic gap 53 on one side or the other of tab 54, which causes plug 33 to move up or down as desired. A position sensor, in this embodiment LVDT 151, extends through chamber 34 and surface 37 of the top face of plug 33. The entire system comprises the pump, the servo-motor and a reservoir of hydraulic fluid, which is packaged into a single self-contained unit. Instead of energy needed to move the controls being supplied by an external hydraulic supply, it is supplied over normal electrical wiring. The EHA draws power when it is being moved, but pressure is maintained internally when the motor stops.

In this embodiment, similar to the first embodiment, the bottom end face of valve plug 33 has pressure-affective area value A2 that is exposed to gas or fluid received in port 32 when valve plug 33 is in the open position. As shown, pressure-affective area value A1 of the top face of plug 33 is almost equal to pressure-affective area value A2 of the bottom face of metering plug 33, such that the gas forces on the valve are almost balanced. The only difference in the area is the result of LVDT 151. The circular openings of passages 35a and 35b are equal on the top face and bottom face of plug 33 and therefore balance out. When valve plug 33 is in the closed seated position shown in FIG. 8, pressure-affective area value A2 is reduced to A3. In the closed position, frusto-conical surface 40 of valve plug 33 is no longer exposed to fluid or gas and pressure on the upstream side 26 of intake port 32, thereby reducing the pressure-affective area value from A2 to A3. Again, the circular openings of passages 35a and 35b are equal on the top face and bottom face of plug 33 and therefore balance out.

Alternatively, an electro-hydraulic actuator (EH) may be used to control movement of plug 33. The electro-hydraulic actuator generally comprise control electronics which create a command input signal, a servo-amplifier which provides a low power electrical actuating signal which is the difference between the command input signal and the feed-back signal generated by the feed-back transducer, a servo valve which responds to this low power electrical signal and controls the flow of hydraulic fluid to plug 33 and sleeve 43 to position plug 33, and a power supply, generally an electrical motor and a pump, which provides the flow of a hydraulic fluid under high pressure. The feed-back transducer measures the output position of the actuator and converts this measurement into a proportional signal which is send back to the servo-amplifier.

As another alternative, the actuator may be a conventional hydraulic actuator. With a hydraulic actuator, an unbalanced pressure applied to valve plug 33 generates the force to move valve plug 33 between the open and closed position.

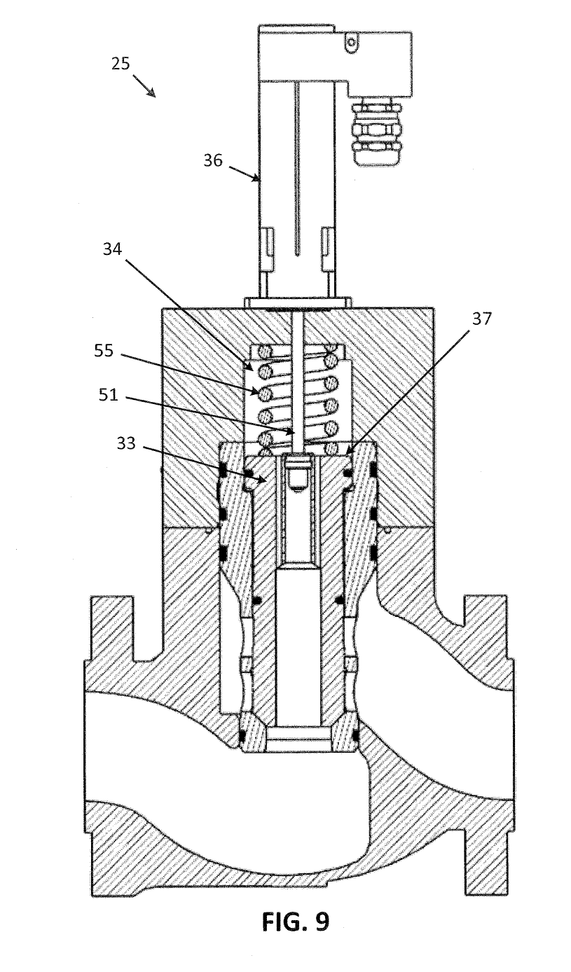

FIG. 9 shows an alternate embodiment in which a fail-safe mechanism is included. In this embodiment, the fail-safe mechanism comprises spring 55 disposed in chamber 34 and acting between surface 37 of plug 33 and the top inner surface of chamber 34 to bias plug 33 towards the closed seated position. If actuator 36 loses power or there is another type of failure, valve assembly 25 will be driven to a closed position. As shown, in this embodiment spring 55 is a torsional spring orientated about shaft 51 so as to urge plug 33 to the closed seated position.

Alternatively, a battery back-up system for actuator 36 may be used. The battery is configured to power the drive for the actuator servo motor during a power failure so actuator 36 can still drive plug 33 to the closed seated position.

With actuator 136, a number of fail safe alternatives may be employed. As with actuator 36 shown in FIG. 9, a spring which exerts force on plug 33 to bias or urge it to the closed seated position may be included. Alternatively, a battery back-up system which powers the drive for the servo motor during a power failure may be included so actuator 136 can drive plug 33 to the closed seated position. Alternatively, an accumulator may be included to drive actuator 136 and in turn plug 33 to the closed seated position. These alternatives are provided as examples only, as other fail-safe mechanisms may be employed.

While a fail safe mechanism that drives valve assembly 25 to a closed position has been shown, as a further alternative, the fail-safe mechanism can be orientated to drive valve assembly 25 to the open position. For example, a spring can be positioned on the other side of plug 33 to bias plug 33 to the open position.

The present invention contemplates that many changes and modifications may be made. Therefore, while an embodiment of the improved gas turbine combustion chamber control valve has been shown and described, and a number of alternatives discussed, persons skilled in this art will readily appreciate that various additional changes and modifications may be made without departing from the spirit of the invention, as defined and differentiated by the following claims.

What is claimed is:

1. A combustion turbine control valve comprising:
a fuel intake flow passage to a combustion chamber of a combustion turbine;
a control valve assembly configured to meter fuel flow through said flow passage to said combustion chamber from an upstream side to a downstream side, said control valve assembly comprising:
a metering valve body having a valve seat defining an inlet port in said flow passage between said upstream side and said downstream side;
a metering valve plug movable relative to said metering valve body from an open position to a closed seated position to control fuel flow through said inlet port from said upstream side to said downstream side;
a chamber separated from said flow passage by said metering valve plug;
said metering valve plug having a first pressure-affective area exposed to said chamber, a second pressure-affective area exposed to said flow passage when in said open position, and a third pressure-affective area exposed to said flow passage when in said closed seated position;
said metering valve body and said metering valve plug configured and arranged such that said first pressure-affective area is greater than said third pressure-affective area; and
a chamber passage connecting said chamber and said upstream side of said flow passage when said metering valve plug is in said closed seated position; and
an actuator configured and arranged to actuate said metering valve body between said closed seated position and said open position;
wherein, when said metering valve body is in said closed seated position, pressure in said upstream side of said passage is transferred to said chamber and will urge said metering valve body to remain in said closed seated position.

2. The combustion turbine control valve set forth in claim 1, wherein said valve seat comprises a frusto-conical seat surface and said metering valve plug comprises a frusto-conical plug surface in said second pressure-affective area of said metering valve plug.

3. The combustion turbine control valve set forth in claim 2, wherein said frusto-conical plug surface is offset relative to said frusto-conical seat surface so as to engage said frusto-conical seat surface and define a circular seal when said metering valve plug is in said closed seated position.

4. The combustion turbine control valve set forth in claim 3, wherein said third pressure-affective area is annular and said circular seal is located proximate to an outer circumference of said annular third pressure-affective area.

5. The combustion turbine control valve set forth in claim 1, wherein said chamber passage extends through said metering valve plug.

6. The combustion turbine control valve set forth in claim 1, wherein said actuator comprises hydraulic ports and a servo system for actuating said metering valve plug between said closed position and said open position.

7. The combustion turbine control valve set forth in claim 1, wherein said actuator comprises an electro-mechanical actuator or an electro-hydrostatic actuator.

8. The combustion turbine control valve set forth in claim 1, wherein said combustion turbine powers an electric generator.

9. The combustion turbine control valve set forth in claim 1, wherein said first pressure-affective area is substantially equal to or less than said second pressure-affective area.

10. The combustion turbine control valve set forth in claim 1, and further comprising a fail-safe mechanism configured and arranged to bias said metering valve body toward said closed seated position.

11. The combustion turbine control valve set forth in claim 1, wherein said fail-safe mechanism comprises a spring disposed in said chamber.
